(19) United States
(12) Patent Application Publication
(10) Pub. No.: US 2015/0058473 A1
(43) Pub. Date: Feb. 26, 2015

(54) NETWORK ADDRESS MAPPING TO NEARBY LOCATION IDENTIFICATION

(71) Applicant: Cisco Technology, Inc., San Jose, CA (US)

(72) Inventor: Cedric Grande, Chippendale (AU)

(73) Assignee: Cisco Technology, Inc., San Jose, CA (US)

(21) Appl. No.: 13/975,905

(22) Filed: Aug. 26, 2013

(51) Int. Cl. H04L 12/24

(52) U.S. Cl. CPC H04L 41/0893
USPC 709/224

(57) ABSTRACT

In one implementation, software workload or device addresses (e.g., IPv4 or IPv6 addresses) are mapped to a nearby physical location identification. The physical location of a dematerialized workload or a device is determined by associating the network address of the dematerialized workload or device to the address of a physical tag. First, the physical tag is sensed in the vicinity of a physical device using short-range technology. Radio frequency identification (RFID), Bluetooth, barcode, near field communication (NFC), or other localized sensing of the location is used to provide the physical location identification. By letting a virtualized endpoint sense the physical location of a nearby physical device, locality is determined.

### TECHNICAL FIELD

This disclosure relates in general to the field of computer networks and, more particularly, to associating a network address to a location.

### BACKGROUND

Network devices are designed to interoperate with each other in networks to carry services. Networks are becoming increasingly more complex. One complexity is virtualized applications. Virtual machines, virtual switches, or other virtualized applications are run by any of various network devices. An instance of a virtualized application may be operated on any of various devices. Regulations, commercial needs, or other considerations may limit the locations at which the virtualized application may run. However, the availability of location information for network devices is limited.

The location of network devices may be manually programmed. When installing a network device in a network, the location is entered as part of the management protocol, such as part of a simple network management protocol (SNMP). However, such manual programming may be inaccurate and does not dynamically detect any changes in location of the virtual application or the device on which the virtual application is instantiated.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts.

FIG. 1 is a simplified block diagram of an example network for mapping an address to a nearby location identification;

FIG. 2 is an example software view of locating a virtualized application;

FIG. 3 is an example packet view of locating a virtualized application;

FIG. 4 is a flow chart of one embodiment of a method for mapping an address to a nearby location identification; and

FIG. 5 is block diagram of a network device, according to one embodiment, for use in determining a location.

### DESCRIPTION OF EXAMPLE EMBODIMENTS

Software workload or device addresses (e.g., IPv4 or IPv6 addresses) are mapped to a nearby physical location identification. The physical location of a dematerialized workload or a device is determined by associating the network address of the dematerialized workload or device to the address of a physical tag. First, the physical tag is sensed in the vicinity of a physical device using short-range technology. Radio frequency identification (RFID), Bluetooth, barcode, near field communication (NFC), or other localized sensing of the location is used to provide the physical location identification. By letting a virtualized endpoint sense the physical location of a nearby physical device, locality is then determined.

In one aspect, a dematerialized workload is run on a first processing device. The dematerialized workload is operable to be run on any of the first processing device or other processing devices. The first processing device and other processing devices are located in different buildings. A code for a tag sensed within a first building is received by a second processing device also within the first building. The second processing device is connected to the first processing device by one hop on a data link layer. A location corresponding to the code is determined. The location is assigned to the dematerialized workload.

In another aspect, logic encoded in one or more non-transitory computer-readable media includes code for execution. When executed by a processor, the code is operable to querying, by a virtual machine, for location information of a first physical network device connected within one hop to a second network device operating the virtual machine, the location information being sensed from a tag in a facility with the first network device, to receive the location information, and to output a network address of the virtual machine and information derived from the location information or the location information associated with the network address.

In yet another aspect, a wireless sensor connects with the gateway device. The wireless sensor is operable to read identification information from a tag located in a room with the wireless sensor. The gateway device is configured to provide the identification information from the tag with an address for a network device connected with the gateway device without any intervening devices. The identification information indicates a location to be associated with a virtualized process running on the network device.

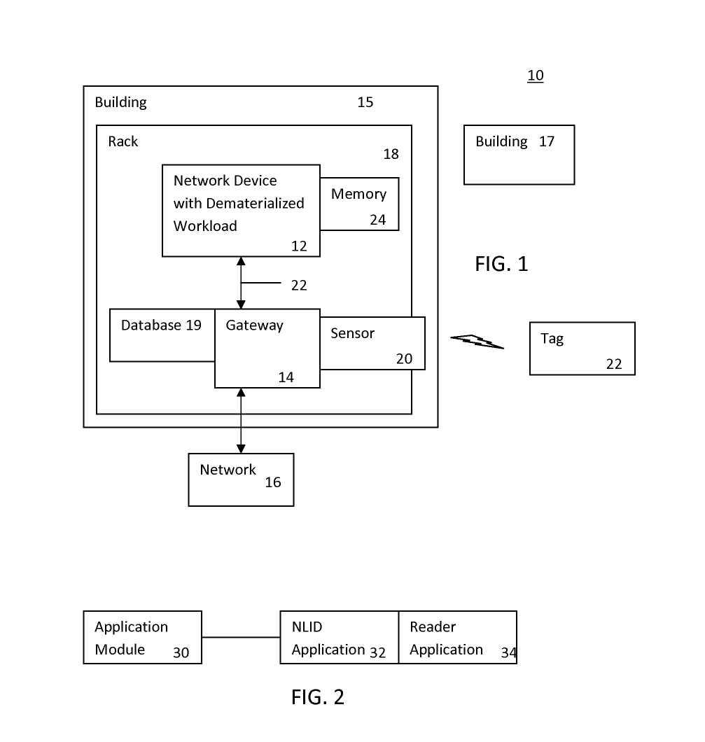

FIG. 1 shows an example network 10 for mapping an address to a nearby location identification. The network 10 or a portion thereof is an apparatus for locating a dematerialized workload or network device. Since a network address is unique to the workload or device within an administrative domain, the location identification is mapped to the address.

The network 10 includes various network devices, including a network device 12, a gateway 14, a sensor 20, and a tag 22. The network 10 connects with or is part of a broader network 16. The network 16 is shown as a box, but may be many different devices connected in a local area network, wide area network, or the Internet. The network 10 includes one device 12 to run the dematerialized workload, but the dematerialized workload may be run on any of various devices, such as devices in either of buildings 15, 17.

Additional, different, or fewer components may be provided. For example, more than one network 16 may connect with the components of the rack 18. As another example, one rack 18 is associated with the gateway 14 and the tag 22, but more than one rack may be associated with the gateway 18 and the tag 22.

The rack 18 is a framework for housing or interconnecting one or more network devices, such as the network device 12 and the gateway 14. The rack 18 is configured to provide power, cooling, card slots, and/or other features for mounting network devices. In an alternative embodiment, the rack 18 is not provided or the gateway 14 and network device 12 are in different racks.

The rack 18 or the network device 12 and the gateway 14 are in a same room, building 15, or facility (e.g., campus, building complex, floor, or other localized region relative to the remote network 16). None or some other network devices may be located in the same rack 18 or same localized region. Other network devices may be located remotely, such as in a different room, building, facility, or relatively remote region. For example, the network 16 includes network devices in a different building, city, state, or country than the network device 12.

The network device 12 is a server, such as a server card in the rack 18. Other network devices may be used, such as a switch, router, gateway, bridge, hub, or repeater. The network device 12 is a processing device. Data is processed by the network device 12, such as processing in response to client requests and/or based on programming.

The network device 12 runs a virtual or dematerialized application. The dematerialized workload is a virtual machine, virtual switch, a virtual appliance, or other software application not resident on a specific device. The dematerialized workload may be run on any of various network devices at various locations. For example, a virtual machine is operated on the network device 12 instead of another remote network device due to the network device 12 having more processing bandwidth, fewer hops, or other criteria. In alternative embodiments, the application is specific to the network device 12.

Since the dematerialized workload may be instantiated on any of various network devices, the physical location of the virtual application is not known or relies on inconsistent manual programming. The location may be important. Local (e.g., state or county) regulations or taxes may dictate different operation and/or relocating of the virtual workload. Other reasons may exist for desiring to know the location of the dematerialized application.

The tag 22 is used to indicate the location. The tag 22 is fixed to the rack 18, positioned in the same room as the rack 18, located in a same building 15, or placed in a same localized region as the network device 12. The tag 22 is fixed permanently, such as with glue or welding. Semi-permanent fixation may be used, such as with screws, bolts, or latches. In other embodiments, the tag 22 is placed without fixation, such as being free-standing. The tab 22 may be in a stationary location, such as a room or building 15, or may be in a moving vehicle, such as a bus, van, boat, or plane.

The tag 22 is a transceiver, antenna, image, or other physical device. In one embodiment, the tag 22 is a RFID responder. Bluetooth, barcode, or other tags may be used. The tag placement, distance, and registration meet any now known or later developed guidelines for compliance with a standard protocol (e.g., ISO 14443 or ISO 15693). Non-standard tags may be used. The tag 22 is designed for sensing within a limited range, such as within a view or a transmission range. Any localized range may be used. For example, a RFID tag has accuracy for detection of between 10 cm to 100 cm. Other ranges may be used, such as ranges generally corresponding to within a room, a building 15, or a campus. Generally is used to account for interference by physical structures and differences between radiation patterns and room or building layout.

The wireless sensor 20 is a transceiver, detector, optical reader, or other sensor for sensing the tag 22. In one embodiment, the sensor 20 is an RFID detector. In another embodiment, the sensor 20 is a barcode reader or Bluetooth transceiver. The sensor 20 detects the tag 22 wirelessly. The tag 22 is not connected by wire to the sensor 20, but may be in other embodiments. Using radio waves or optics, the sensor 20 detects the tag 22.

The detection is of a code associated with the tag 22. The code is detected, such as the tag 22 responding with an address assigned to the tag 22. Other codes than addressing may be used, such as a unique identifier. Any identification information may be used, such as a frequency, data, differences, or other characteristics. The identification information may be used to associate different tags 22 with different locations. The identification information may be the location itself, a network address, or tag serial number.

The wireless sensor 20 connects with the gateway device 14. The connection may be physical, such as integrating the wireless sensor 20 within a same housing as the gateway device. The connection may be electrical, such as having a wired or wireless communications connection. For example, the sensor 20 is mounted in the rack 18 near to or spaced from the gateway 14. As another example, the sensor 20 is mounted in a same room or building 15 as the gateway 14, but not a same rack. A universal serial bus (USB) or other connection is used to connect the sensor 20 to the gateway device 14. In other embodiments, the sensor 20 connects with a different component of the network 10, such as connecting with another network device than the gateway 14. More than one connection may be provided, such as the sensor 20 being a networked device for communicating with a plurality of other network devices, including the network device 12. In yet another embodiment, the network device 12 includes the sensor 20 without an intermediary connection through the gateway 14. The physical infrastructure device (e.g., gateway 14) able to read the location tag 22 is able to communicate with the dematerialized workload in the network device 12.

Where the sensor 20 may detect multiple tags 22, the code for the desired tag 22 may be isolated. Range and/or signal strength may indicate the proper tag 22, such as using the code from the closest tag 22. The amount of time that a tag 22 is detected may be used, such as using code from a tag 22 detected over a day and not using code from a tag detected for less than a day. The code or tag identification may be cross checked with a list or range of valid values. If the code or identification is not in the list, then the code from that tag 22 is not used.

The gateway device 14 is a network interface card, a top-of-rack switch, other switch, router, firewall, or other network device. The gateway device 14 is a processing device for communicating with the network device 12, the sensor 20, and/or the network 16. Communications with other network devices may also be provided. The gateway device 14 is in the rack 18 with the network device 12 hosting the dematerialized workload, but may be located elsewhere.

The gateway device 14 connects with the network device 12 over one or more wires. For example, Fiber runs or Ethernet cables connect the gateway device 12 to the network device. Short range wireless connectivity may also be acceptable. There are no intervening devices, so the wire directly connects the gateway and network devices 12, 14. On the data link layer (i.e., Layer 2 of TCP/IP), the gateway device 14 is one hop from the network device 12. A single hop or direct data link connection is provided. In other embodiments, more than one hop and/or intervening devices (e.g., a switch) are between the gateway and network devices 12, 14.

The one hop connection may be used to limit the location detection to the localized region. Any probes or queries received by the gateway device 14 from the network device 12 are not allowed to propagate or broadcast past the first layer 2 hop to limit the number of replies being received, and to ensure only the closest gateway device 14 replies. The probes are not sent using a plain broadcast mechanism, otherwise the probe would be seen by other switches in the same layer 2 domain as well. The gateway device 14 recognizes the location packets from the dematerialized workload running on the network device 12 and does not forward or flood the packets. In another approach, a media access control (MAC) address (e.g., 48 or 64 bits) is reserved. Communications regarding the tag code or other location information use the reserved MAC address for communications to limit forwarding.

Logic is encoded in one or more non-transitory computer-readable media for operating the network device 12 and/or the gateway 14. The media is a memory, such as the memory 24 for the network device 12. Other memories within or outside the network 10 may be used. The logic includes code for execution by a processor or processors. When executed by a processor, the code is used to perform operations for determining the geographic location of the dematerialized workload or the network device 12. The logic code is used to configure the devices 12, 14 to perform operations.

Different embodiments of the logic code and the devices configured by the logic code are provided. In some of the embodiments, the identification information is read from the closest physical tag by interacting with the sensor 20. Using a localized or remote look-up, the location associated with the tag identification is determined. The location is locally and/or remotely assigned to the dematerialized workload on the networking device 12. Identification information from the tag is associated with or assigned to the address for the dematerialized workload, such as assigning to the IPv4 or IPv6 address of a virtual machine running on the network device 12. Due to the one hop limitation or no intervening devices, the location associated with the tag sensed by the gateway device 14 applies to the workload on the local network device 12.

The identification information from the local tag 22 may be used by various devices in different approaches to assign the location to the dematerialized workload (e.g., virtualized process) on the network device 12 or the network device 12. The logic code of the application or on the network device 12, gateway 14, sensor 20, or other network device provides the operation discussed herein.

In one embodiment, the gateway device 14 looks-up the location from the tag identification and provides the location to the virtual application or to a database 19. The database is maintained at or for the gateway device 14, but may instead or additionally be maintained in the network 16 or other remote location. The gateway device 14 provides the identification information or the location to any virtual application within one hop.

FIG. 2 shows an example software view for this embodiment. The application module 30, such as the virtual machine on the network device 12, communicates with the nearby location identifier (NLID) application 32 run on the gateway device 14. The NLID application 32 is integrated with, controls, or contacts the reader application 34 of the sensor 20. The reader application 34 provides the location information, such as a location or a tag identifier that may be used to look-up the location.

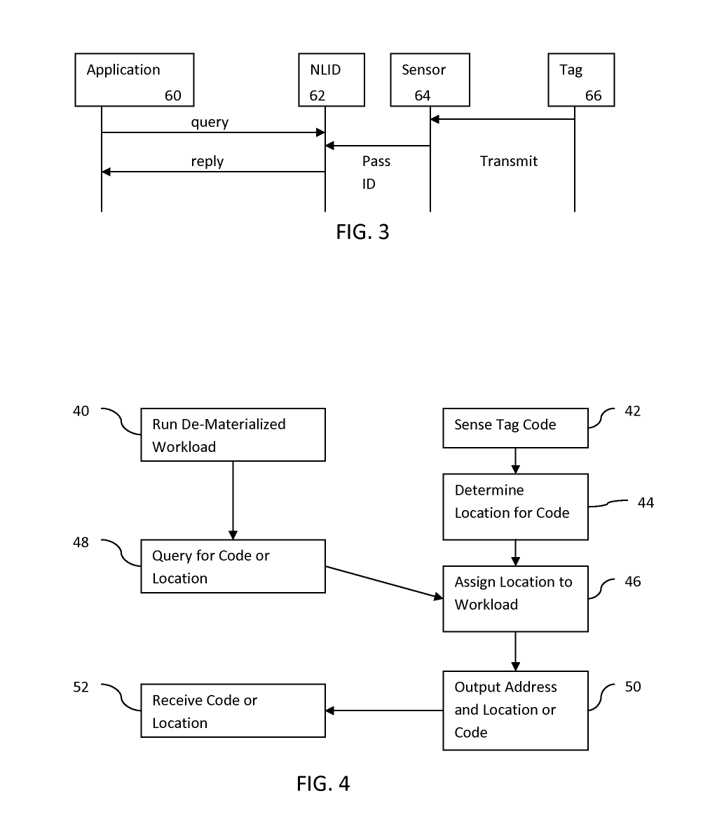

FIG. 3 shows an example packet view for one approach of this embodiment. The virtual application 60 sends a query to the NLID 62. The virtual application 60 includes logic code for querying about the location of the network device 12 on which the virtual application 60 is operating. The NLID 62, using the sensor application 64, receives the passed identification information from the tag code 66. The identification is passed before or after receiving the query. In response to the query, the NLID 62 replies with the tag code 66 or location information looked-up from the tag code 66.

In this example, the virtual application 60 performs the probing directly to find out the location of itself (i.e., the application). This situation occurs when the developer implements the NLID query function in the virtual application 60. The first hop physical infrastructure device (e.g., gateway device 14) includes code to reply to such probes. Alternatively, a virtual device (e.g., virtual switch) receiving the probe may proxy the replies (e.g., virtual switch).

In this response-query arrangement, the processor of the gateway device 14 or other network device responding to NLID queries may become overloaded if too many probes are received. A default or required probe interval may be established to limit the number of probes, such as a default of 30 minutes with a limit of at least 5 minutes. Any amount of time may be used for the default or the limit. Any amount of time may be programmed. A randomized interval may be used. The processing burden may be limited by processing NLID probes in a non-priority queue of the processor.

Security may be provided for the query-reply process. Encryption in communications, exchange of certificates, or other security process may be used. Authentication may be used.

In another embodiment, the virtual application obtains location information from a database. For example, the virtual application receives the tag identification information. The virtual application accesses a centralized database associating location with the tag, so acquires the location using the tag information. As another example, the virtual application queries a centralized database for the location and/or tag identification. The gateway device 14 or NLID 32 provides the tag identification and addresses associated with any one-hop connected application modules 30 or network devices 12. For example, the gateway 14 communicates its address resolution protocol (ARP) table and location or tag identifier to a centralized management authority. The application module 30 provides an address. The address is used by the centralized database to look-up the location or tag identification then used to look-up the location.

In another embodiment, the database at the centralized authority may be used even where the virtual application 30 does not query for the information. If the dematerialized workload does not implement NLID polling, the location information linked to the IP address is provided for use by other devices or applications. The NLID application 32 associates the tag identification or location with addresses of one-hop connected devices 12 and/or applications 30. For example, an operator of the application 30 may gather the information without integrating the code into the application 30. The operator or other party provides the address of the virtualized application 30 to look-up the location or to look-up the tag identification that can be used to look-up the location. Alternatively, the address of the gateway 14 or sensor 20 is used. Knowing that the network device 12 is at a same location, the location of the network device 12 and/or virtual application is determined from looking up the location using the address of the gateway 14 or the sensor 20.

The association of the address of the virtual application 30 with the location is performed for any identified virtual application 30. Alternatively, the association is provided for all physical network devices 12. Identification of the network device 12 on which the virtual application 30 operates is used to determine the location of the virtual application. Multiple virtual applications 30 and/or network devices 12 sharing a same location and/or tag identification indicates operation in a same localized area associated with the tag 22.

In one embodiment, the location information, such as the location or tag identifier, is integrated into a SNMP location string or other register. The application 30, the network device 12, the gateway device 14, and/or the NLID 32 provide the location information to a server, operator, or other device or application for populating manually or automatically the location information into the management protocol.

Any of the various applications and/or devices may look-up the location from the tag identification or code. Alternatively, the tag 22 is programmed to provide the location as the code rather than or in addition to an identifier. Any of the various applications and/or devices may query for the location information. Any of the various applications and/or devices may assign the location information to the application or network device, such as assigning location to a network address. Local, remote, or local and remote processes may be involved, such as for storing addresses associated with locations.

FIG. 4 shows an example method for mapping an address to a nearby location identification. An address for a dematerialized workload or network device is associated with a location. The location is sensed using localized sensing.

The method is implemented by the network of FIG. 1, the software of FIG. 2, or by other networks or software. Any of various devices and corresponding applications may implement all or portions of the method. For example, the network device 12 runs the dematerialized workload as the application 30 in act 40. The application 30, network device 12, gateway 14, NLID application 32, sensor 20, sensor application 34, or a remote application of the network 16 queries for code or location in act 48. The determination of the location for the code is performed by any of these devices or applications or by a different (e.g., remote) application. Similarly, the output in act 50, receipt in act 52, or assignment of act 46 is performed by any of the applications or devices.

Additional, different, or fewer acts may be provided. For example, different embodiments result in different processors implementing the acts. Other acts associated with the arrangement being used are provided. Where the virtual application queries in act 48 and receives the code or location in act 52, the virtual application may provide a further output act to a management system or application owner. In another example, act 48 is not provided where the NLID pushes or gathers and stores location or identification information without request.

The acts are performed in the order shown or a different order. Acts 40 and/or 48 are performed before, after, or simultaneously with act 42, act 44, and/or act 46.

In act 40, a dematerialized workload is run on a processing device, such as a processor of a network device. Any application or process represents work to be performed—a workload. The dematerialized workload is a virtualized machine, switch, or appliance. Rather than having an assigned server, machine, switch, or appliance for a given application or workload, the workload is not restricted to a device. The workload may be located on any available device (e.g., devices in either of buildings 15, 17 of FIG. 1). The virtual application may be instantiated at any of various devices, depending on any criteria.

In act 42, a tag code is sensed. In response to a transmission from the sensor, the tag responds with the code. Alternatively, the tag transmits the code periodically without being a response. The sensing occurs periodically or in response to a trigger. For example, the sensing occurs in response to a request. As other examples, the sensing occurs at regular intervals or upon power up of hardware.

The sensing is within a building 15 or other localized region. The sensing may be limited to a room or a region. Any size region may be used, such as 10-100 cm, 10 yards or less, 100 meters or less, or a number of kilometers or less. The strength of the transmission from the sensor and/or the response from the tag may limit the sensing region.

The nature or standard followed for sensing may limit the region. Localized sensing techniques are used, such as RFID, Bluetooth, or barcode reading. The tag is within range of the sensor, so a known location of the tag may be imparted to the sensor. Where other network hardware is near the sensor, the location is imparted to the network hardware. When a virtualized application operates on the network hardware, the location is imparted to the virtualized application.

In act 44, the location corresponding to the tag code is determined. In one embodiment, the tag is programmed or coded with the location. The tag code is or includes the location. The location is extracted from or is the code.

In another embodiment, the code is used to look-up the location. A database of tags and corresponding locations of the tags is maintained. Each time a new tag is placed, the installer updates the database with the tag code and corresponding location. Alternatively, the tag uses the global positioning system (GPS), cellular communications (e.g., closest tower or triangulation), or other location detection to automatically determine the position of the tag and wirelessly reports the tag code and location for updating the database or including in the tag code.

The tag, sensor, network device connected with or controlling the sensor, or other network device determines the location from the code. Any device with network communications access may look-up the location from the code. The location is stored or passed on to other devices, such as other devices connected to the sensor, tag, or network device controlling the sensor.

In act 46, the location is assigned to one or more dematerialized workloads and/or network devices. The dematerialized workload instantiates and operates on a network device. Where the location of the network device is known due to sensing the local tag, the location is assigned to the dematerialized workload. For example, the location is associated with the internet protocol address (e.g., IPv4 or IPv6) of the dematerialized workload. The virtual application has a unique address for operating in the network. The location is associated with that address.

The assignment occurs locally. The dematerialized workload associates its address with the location. The location may be populated in a register, added to a header, or communicated in a payload for the association. The location may be associated by entering the workload address and corresponding location in a database. Other local devices or applications, such as a location identification application in a gateway, may associate the location with the workload address. In alternative embodiments, a remote server or processor performs the association. Information indicating that the dematerialized workload is at or near the location is used to associate in a database.

The assignment is of a geographic coordinate, a region name (e.g., server farm 1), a city, a state, a country, or other label for a localized region. The assignment of the location may be by association with the tag code or identification. While the tag code or identification may not itself indicate the location, a database or other resource is available to indicate the location based on the tag code. The tag code is a proxy or indicator of the location.

In act 48, a query is performed for the code or location. Identification information is queried. In one embodiment, the dematerialized workload (e.g., virtual machine) performs the query. Upon instantiating, the workload generates a query from the network device on which the workload instantiates. The query is to a gateway, to all layer 2 connections, or to one or more network devices or applications on the network devices. The query requests location information. To maintain localization, the query is for a single hop in layer 2. More than one hop may be used in other embodiments. In response to the query, the location is assigned to the workload or device in act 46.

In another embodiment, an application on the gateway or connected with the sensor queries. For example, the code is queried and used to determine the location by look-up. As another example, the location is queried from a database of previously assigned locations by code. In yet other embodiments, the query is by a workload owner or remote network device, such as a management workstation. The address or routing indicates the location of the dematerialized workload relative to a gateway or other device associated with the sensor. The query is for the location or code in order to associate the dematerialized workload with the location.

In act 50, the address and location or code are output. In response to the query, the unique address of the dematerialized workload and the associated location information are output. The gateway or other device with the location information replies to the query with the code or location.

Alternatively, just the location information or just the address is output. For example, the query is for addresses of any virtual machines at a given location or region.

The output is of the code, location, or other information derived there from. The location may be coded, such as encrypted. A distance may be determined using the location. Other derivations from the location may be used.

The information output may be limited. The resolution of the geographic location may be altered depending on the query. A specific region (e.g., city) may be associated with the dematerialized workload, but a more generic region (e.g., state) is output in response to the request. For example, the location information may be tied to a LISP end-point identification (EID) or RLOC, and a LISP mapping system leveraged to determine what information to output in the query response for a given tag. A null response or no location may be output. This variation of limited location may allow for commercial considerations, such as providing a pay-for service to indicate location. If one level of payment is made, a given location resolution is used, while a greater location resolution is provided for a greater payment.

In act 52, the code or location is received. Where the dematerialized workload and corresponding network device requested the code or location, the output code or location is received by the dematerialized workload and corresponding network device. Where multiple indications of location are received, such as from different one-hop connected devices, any criteria may be used for selecting. The location associated with the temporally longest connected device may be used. The last received location may be used. The first received location may be used (e.g., closest likely to reply first).

If a reply is not received by the dematerialized workload, the last entry is kept. This may occur for any number of queries. If no reply is received to a certain number of queries (e.g., 4), the workload may have moved locations or the old location information may no longer be trusted. The location is nullified. Alternatively, the old location continues to be used. If a reply is received with a null location, this may indicate that no physical tag or location identified could be read. The location is nullified. A notification may be sent to arrange for installment or correction of the tag reading.

Where other devices and/or applications requested the location information, the other devices or applications receive the response. For example, a database populated with addresses and corresponding locations queries. The database is local to or remote from the tag. The response to the database includes the location information. As another example, a local device queries a remote database for the location information, so the local device receives the response with the location information.

The location information for a dematerialized workload or network device may be used in any manner. The owner of the workload may use the location for tax or regulation monitoring. The location may be communicated to a mapping database (e.g., LISP mapping structure) for consumption by various services.

The location may be used to optimize workload location. Power, cooling, maintenance, active/dr cell, or other consideration may be used to shift or have the dematerialized workload change location.

The location may be used for inventory or network management. By detecting the location of devices (e.g., all within L2 1^{st} hop), the current location of mobile or moveable devices is determined. For example, the location of a moved blade server may be determined. Similarly, facility maps may be generated. An inventory of devices within a facility or localized region is collected.

The location may be used to assess physical distances between tiers, application services, virtual cluster members, or other arrangements. Interactive services may be clustered or aggregated into similar or the same location to reduce latency. For example, the location may gauge distribution of cluster members when interconnected via overlays (e.g., L2 overlay).

The location may be used for assessment of geo-coordinates of software workload. Where the dematerialized workload does not satisfy location specific regulations, the workload may be moved. The workload may be allowed in some and not other hosting facilities, such as in ITaaS/Cloud resource consumption model (e.g., public/hybrid). The location is used to assure proper location relative to the facility. Some workloads may have an assigned level of security. Location may be used to assure that the workload is instantiated in a sufficiently secure hosting facility, such as a secure data center.

The location may be used to conserve bandwidth of a gateway. An overlay, such as a virtual private network, may be created between gateways (e.g., in SDN context, with or without central controller). Rather than terminating at the gateway, the overlay may terminate at the closest physical device to the dematerialized workload. The overlay is assigned to be as close as possible to the virtual workload but without requiring an overlay termination point or encryption to be done on the software application, workload, or virtual switch.

The location may be used in the context of the ongoing network function virtualization efforts (NfV). The optimal placement of virtualized services may be determined based on the locations of the various applications. For example, firewall and intrusion detection are moved closer to the workload to reduce latency. As another example, a service may be moved to a virtual machine if the tunneling distance is too long.

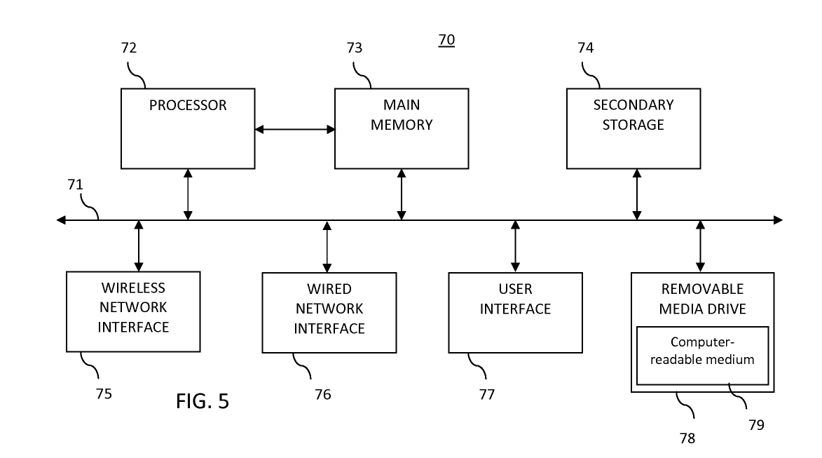

FIG. 5 is a simplified block diagram of an example network device 12, 14, such as a general or special purpose computer. The network 10 may be for a single domain (e.g., cisco.com) or multiple domains (e.g., cisco.com and pepsi.com). For example, the network may be a wide area network, local area network, intranet, extranet, wireless local area network, virtual local area network, or combinations of networks for one or more companies. Any form of network may be provided, such as transport networks, enterprise, data center, or other wired or wireless network. The network 10 may be applicable across platforms, extensible, and/or adaptive to specific platform and/or technology requirements through link-negotiation of connectivity.

The network 10 may be relatively static, such as the same network devices 12, 14 being provided over minutes, days, weeks, or years. Network devices 12, 14 may be occasionally added or replaced. In other embodiments, the network 10 is dynamic, such as allowing network devices 12, 14 to be added or removed frequently. For example, mobile network elements may connect or disconnect from the network 10 throughout a day.

The network devices 12, 14 are connected over links through ports. Any number of ports and links may be used. The ports and links may use the same or different media for communications. Wireless, wired, Ethernet, digital subscriber lines (DSL), telephone lines, T1 lines, T3 lines, satellite, fiber optics, cable and/or other links may be used. Corresponding interfaces are provided as the ports.

In FIG. 5, the example network apparatus or device 70 corresponds to network elements or computing devices that may be deployed in the network 10. The network device 70 includes software and/or hardware to perform any one or more of the activities or operations for determining location of virtualized applications or network devices.

The network device 70 includes a processor 72, a main memory 73, secondary storage 74, a wireless network interface 75, a wired network interface 76, a user interface 77, and a removable media drive 78 including a computer-readable medium 79. A bus 71, such as a system bus and a memory bus, may provide electronic communication between processor 72 and the other components, memory, drives, and interfaces of network device 70.

Additional, different, or fewer components may be provided. The components are intended for illustrative purposes and are not meant to imply architectural limitations of network devices 12, 14. For example, the network device 70 may include another processor and/or not include the secondary storage 74 or removable media drive 78. Each network device 12, 14 may include more or less components than other network devices 14.

The processor 72, which may also be referred to as a central processing unit (CPU), is any general or special-purpose processor capable of executing machine readable instructions and performing operations on data as instructed by the machine readable instructions. The main memory 73 may be directly accessible to processor 72 for accessing machine instructions and may be in the form of random access memory (RAM) or any type of dynamic storage (e.g., dynamic random access memory (DRAM)). The secondary storage 74 may be any non-volatile memory, such as a hard disk, which is capable of storing electronic data including executable software files. Externally stored electronic data may be provided to computer 70 through one or more removable media drives 78, which may be configured to receive any type of external media 79, such as compact discs (CDs), digital video discs (DVDs), flash drives, external hard drives, or any other external media.

The wireless and wired network interfaces 75 and 76 may be provided to enable electronic communication between the network device 70 and other network devices 12, 14 via one or more networks. In one example, the wireless network interface 75 includes a wireless network controller (WNIC) with suitable transmitting and receiving components, such as transceivers, for wirelessly communicating within the network 10. The wired network interface 76 may enable the network device 70 to physically connect to the network 10 by a wire, such as an Ethernet cable. Both wireless and wired network interfaces 75 and 76 may be configured to facilitate communications using suitable communication protocols, such as the Internet Protocol Suite (TCP/IP).

The network device 70 is shown with both wireless and wired network interfaces 75 and 76 for illustrative purposes only. While one or both wireless and hardwire interfaces may be provided in the network device 70, or externally connected to network device 70, only one connection option is needed to enable connection of network device 70 to the network 10. The network device 70 may include any number of ports using any type of connection option.

A user interface 77 may be provided in none, some or all machines to allow a user to interact with the network device 70. The user interface 77 includes a display device (e.g., plasma display panel (PDP), a liquid crystal display (LCD), or a cathode ray tube (CRT)). In addition, any appropriate input device may also be included, such as a keyboard, a touch screen, a mouse, a trackball, microphone (e.g., input for voice recognition), buttons, and/or touch pad.

Instructions embodying the activities or functions described herein may be stored on one or more external computer-readable media 79, in main memory 73, in the secondary storage 74, or in the cache memory of processor 72 of the network device 70. These memory elements of network device 70 are non-transitory computer-readable media. The logic for implementing the processes, methods and/or techniques discussed herein are provided on non-transitory computer-readable storage media or memories, such as a cache, buffer, RAM, removable media, hard drive or other computer readable storage media. Computer readable storage media include various types of volatile and nonvolatile storage media. Thus, ‘computer-readable medium’ is meant to include any medium that is capable of storing instructions for execution by network device 70 that cause the machine to perform any one or more of the activities disclosed herein.

The instructions stored on the memory as logic may be executed by the processor 72. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

Additional hardware may be coupled to the processor 72 of the network device 70. For example, memory management units (MMU), additional symmetric multiprocessing (SMP) elements, physical memory, peripheral component interconnect (PCI) bus and corresponding bridges, or small computer system interface (SCSI)/integrated drive electronics (IDE) elements. The network device 70 may include any additional suitable hardware, software, components, modules, interfaces, or objects that facilitate operation. This may be inclusive of appropriate algorithms and communication protocols that allow for the effective protection and communication of data. Furthermore, any suitable operating system is configured in network device 70 to appropriately manage the operation of the hardware components therein.

One or more of the memories 73, 74, 79, or another memory stores the location information (e.g., tag code or location) and address or other application or device identifier. One or more memories 73, 74, 79, or another memory may store a database of addresses or identifiers and associated location information.

The processor 72 is configured to sense, query, respond, associate, assign, and/or perform other actions associated with localizing a dematerialized workload or network device. Working with other network devices 12, 14, the processor 72 of a given network device 12, 14 acquires, associates, or uses the location information.

The top of rack physical switch or other network device sensing the tag may hand-over a proxy function to some virtual switch to which the dematerialised workload connects. The query response function may be offloaded in massively scalable environments (e.g., the physical first hop detects the tag and asks some virtual switch closer to the virtual machine to reply to NLID queries).

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. A method comprising:
running a dematerialized workload on a first processing device, the dematerialized workload operable to be run on any of the first processing device or other processing devices, the first processing device and other processing devices located in different buildings;
receiving a code for a tag sensed within a first building by a second processing device also within the first building, the second processing device being connected to the first processing device by one hop on a data link layer;
determining a location corresponding to the code; and
assigning the location to the dematerialized workload.

2. The method of claim 1 wherein running the dematerialized workload on the first processing device comprises running a virtualized machine, virtualized switch, or virtualized appliance with the first processing device comprising a server.

3. The method of claim 1 wherein running the dematerialized workload comprises running an application operable to have an instance at any of the first and other processing devices.

4. The method of claim 1 wherein receiving comprises sensing the code from an RFID tag.

5. The method of claim 1 wherein receiving comprises sensing the code from a Bluetooth device.

6. The method of claim 1 wherein receiving comprises sensing a barcode from a bar-coded tag.

7. The method of claim 1 wherein receiving comprises sensing wirelessly from the tag, the tag fixed to a rack holding the first processing device and the second processing device.

8. The method of claim 1 wherein receiving comprises sensing within a range limited to ten yards or less.

9. The method of claim 1 wherein receiving comprises sensing with the second processing device having a wired connection to the first processing device and without any intervening processing devices in the wired connection.

10. The method of claim 1 wherein determining the location comprises looking up the location based on the code or extracting the location from the code.

11. The method of claim 1 wherein assigning the location comprises associating the code or the location with an internet protocol address of the dematerialized workload.

12. The method of claim 1 further comprising:
querying, by the first processing device, the second processing device for the code or the location;
replying, by the second processing device, with the code or the location.

13. Logic encoded in one or more non-transitory computer-readable media that includes code for execution and when executed by a processor is operable to perform operations comprising:
querying, by a virtual machine, for location information of a first network device connected within one hop to a second network device operating the virtual machine, the location information being sensed from a tag in a facility with the first network device;
receiving the location information; and
outputting a network address of the virtual machine and information derived from the location information or the location information associated with the network address.

14. The logic of claim 13 wherein querying comprises querying the first network device.

15. The logic of claim 13 wherein querying comprises querying a database of other network devices, including the first network device, and the corresponding location information for the other network devices.

16. An apparatus comprising:
a gateway device; and
a wireless sensor connected with the gateway device, the wireless sensor operable to read identification information from a tag located in a room with the wireless sensor;
wherein the gateway device is configured to provide the identification information from the tag with an address for a network device connected with the gateway device without any intervening devices, the identification information indicating a location to be associated with a virtualized process running on the network device.

17. The apparatus of claim 16 wherein the gateway device is configured to provide the identification information or the location to the virtualized process in response to a request from the virtualized process, and wherein the gateway device is configured to terminate the request without forwarding.

18. The apparatus of claim 16 wherein the gateway device comprises a network interface card or a top-of-rack switch, and wherein the wireless sensor comprises a radio frequency identification reader, a Bluetooth transceiver, or a barcode reader.

19. The apparatus of claim 18 wherein the gateway device is in a rack with the network device, a wire connecting the gateway device to the network device, and wherein the identification information for the tag associated with the location in a database.

20. The apparatus of claim 16 wherein the gateway device is configured to look-up the location with the identification information, to associate the location with the network device and other network devices within one hop of the data link layer, and output addresses for the network device and other network devices as associated with the location.
